(19) United States
(12) Patent Application Publication
(10) Pub. No.: US 2016/0292792 A1
(43) Pub. Date: Oct. 6, 2016

(54) SYSTEM AND METHOD FOR INTERCONNECTING ACCOUNTING OPERATIONS

(71) Applicant: SAP SE, Walldorf (DE)

(72) Inventors: Reiner Wallmeier, Wiesloch (DE); Bernhard Fischer, Karlsruhe (DE)

(21) Appl. No.: 14/674,395

(22) Filed: Mar. 31, 2015

(51) Int. Cl. G06Q 40/00; G06Q 20/14

(52) U.S. Cl. CPC G06Q 40/12; G06Q 20/14

(57) ABSTRACT

A method and system for receiving, storing, calculating, creating and making accessible sub ledgers to some or all of the business parties sharing a cloud computing space are provided. A business transaction which creates an accounting event is engaged in. As a result, an open item in the first party's sub ledger relating to the business transaction is created. A corresponding open item in the second party's sub ledger based on the open item in the first party's sub ledger is created. The open item and the corresponding open item is presented to the parties.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyrights whatsoever.

### BACKGROUND INFORMATION

Accounting operations between two or more business parties (“parties”) engaging in business transactions between each other include maintaining a separate sub ledger by each party. For example, if the first party is a seller and the second party is a buyer, the first party maintains an internal accounts receivable sub ledger summarizing the purchases of the second party, and the second party maintains an internal accounts payable sub ledger summarizing its purchases from the first party.

A typical example of a business transaction between the parties comprises placing an order by the buyer, confirming the order by the seller, shipping the ordered goods by the seller, receiving the goods by the buyer, sending an invoice to the buyer, and making a payment by the buyer. This list is not exhaustive and the order may differ. Nonetheless, many of the mentioned interactions create accounting events on the part of the buyer or seller. For example, upon invoicing the buyer for the ordered goods, the seller's accounts receivable sub ledger shows an open item relating to the sale and the seller's accounts receivable increases by the invoiced amount. The buyer's accounts payable sub ledger does not reflect the open item and invoiced amount until the invoice is received by the buyer and properly entered into the buyer's accounts payable sub ledger.

Since the parties maintain their sub ledgers separately, inconsistencies and errors frequently arise. For example, upon receiving the invoice, the buyer might not accurately enter the invoiced amount into its accounts payable sub ledger (i.e. human error). Events of this kind, some of which tend to be random in nature, create discrepancies between the sub ledgers of the parties. A more systematic source of inconsistencies is incomplete or imprecise agreements between the parties on the terms of the transaction. For example, the buyer orders goods and assumes free shipping while the seller assumes to bill shipping costs to the buyer.

As a result, frequent cross-checking and reconciling of the accounts between the parties is required. Cross-checking and reconciling is resource and headcount intensive and costs the parties a great deal of time and money. Moreover, the resulting reconciliation prolongs transaction cycle times. There can be benefit in creating an accounting operations system environment which can avoid or prevent such problems.

### BRIEF DESCRIPTION OF THE DRAWINGS

FIG. 1 illustrates an exemplary accounting operations system according to a first example embodiment.

FIG. 2 illustrates an exemplary embodiment of a cloud computing space.

FIG. 3 is a flowchart of an exemplary method for interconnecting accounting systems according to an example embodiment.

FIG. 4 illustrates an exemplary accounting operations system according to a second example embodiment.

FIG. 5 illustrates an exemplary accounting operations system according to a third example embodiment.

FIG. 6 illustrates an exemplary accounting operations system according to a fourth example embodiment.

FIG. 7 illustrates an exemplary accounting operations system according to a fifth example embodiment.

### DETAILED DESCRIPTION

The present invention provides for a method and system for interconnecting and consolidating accounting operations between two or more business parties by interconnecting their sub ledgers. More specifically, the present invention relates to a method and system for receiving, storing, calculating, creating and making accessible the sub ledgers to some or all of the business parties sharing a cloud space.

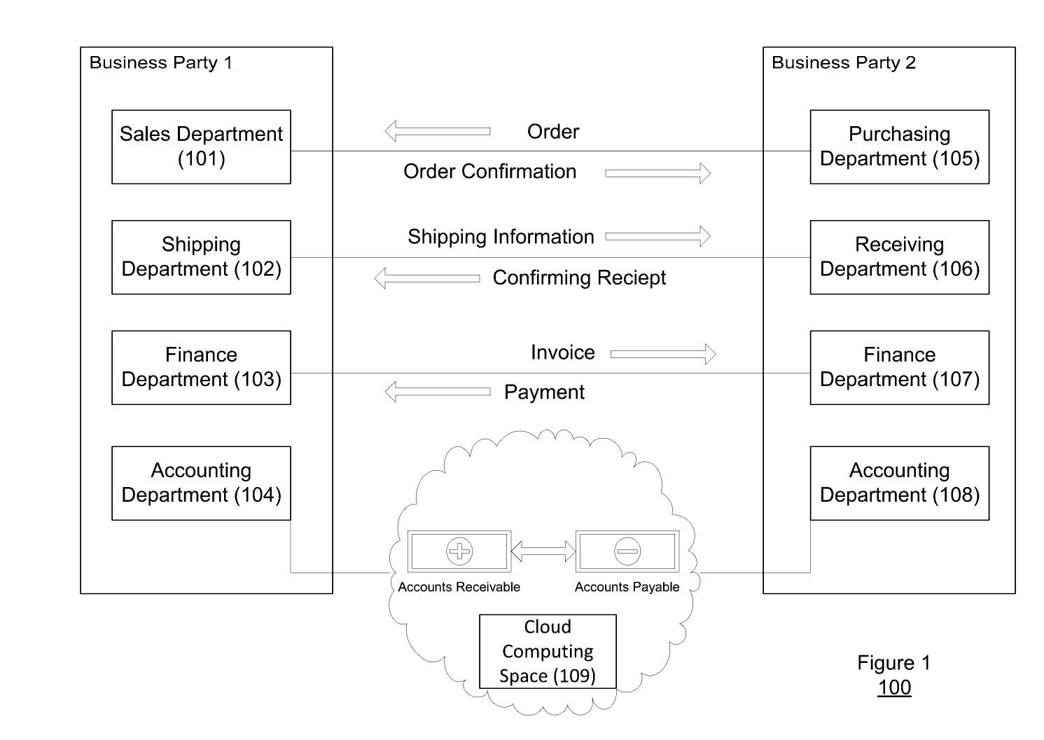

FIG. 1 illustrates an exemplary accounting operations system 100 interconnected and consolidated according to a first example embodiment. The accounting operations system 100 includes two business parties 1 and 2. Business party 1 may be a seller and business party 2 may be a buyer. Business parties 1 and 2 need not always maintain the same business relationship and they may engage in other business activities between themselves.

Each business party has its own internal business entities. In FIG. 1, for example, business party 1 comprises a sales department 101, shipping department 102, finance department 103, and accounting department 104. Similarly, business party 2 comprises a purchasing department 105, receiving department 106, finance department 107, and accounting department 108. Each business party may comprise fewer or more entities.

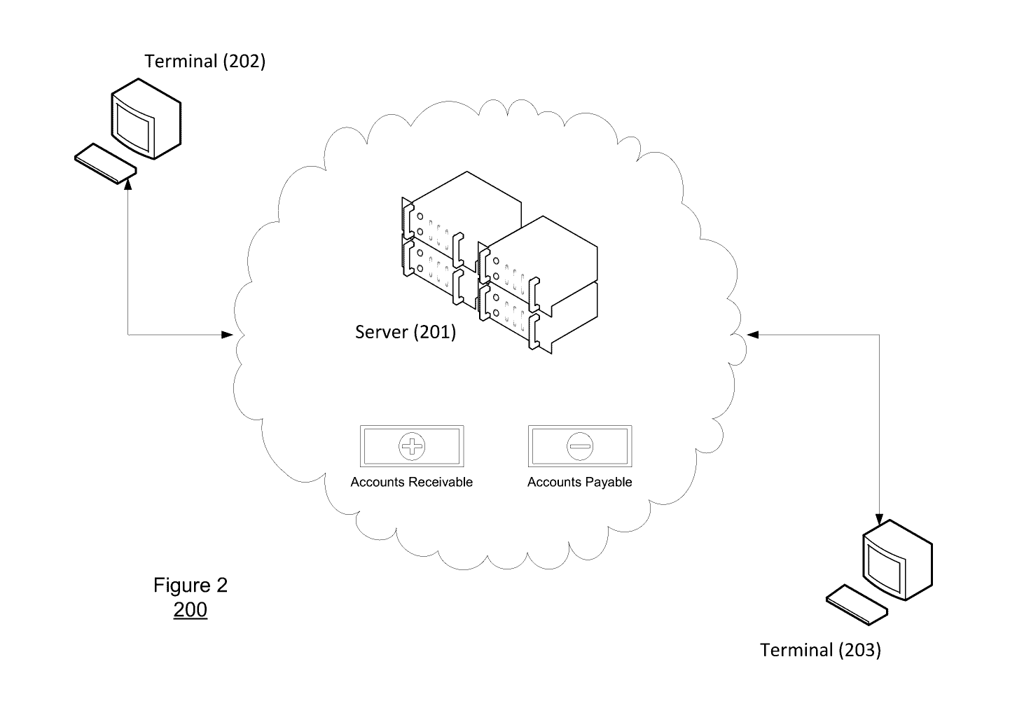

The business parties 1 and 2 share a cloud computing space 109. FIG. 2 illustrates an exemplary embodiment of a cloud computing space such as cloud computing space 109. The cloud computing space comprises at least one server 201 and a plurality of terminals. In this embodiment, there are two terminals 202 and 203. The server 201 is configured to communicate with the terminals 202 and 203. The server 201 may receive and store information from each one of the terminals 202 and 203. The terminals 202 and 203 may also change or rewrite the information already stored on the server 201. Each one of the terminals 202 and 203 has access to all or some of the information stored on the server 201. The server 201 may analyze and calculate new information based on the information stored on it.

The following is an exemplary transaction that the business parties 1 and 2 in FIG. 1 may enter into: Party 2 places an order. Party 1 provides an order confirmation to party 2. Thereafter, party 1 ships out the purchased goods and provides the shipping information to party 2. Upon receiving the shipment, party 2 confirms receiving the goods. Subsequently, party 1 sends out an invoice for the goods sold. After receiving the invoice, party 2 makes the requested payment. This is, however, only an exemplary transaction. One of ordinary skill in the art recognizes that a transaction may include fewer or more steps, may be conducted in a different order, and is not limited to purchase of a goods.

Many of the mentioned interactions between the parties create accounting events. For example, upon issuing an invoice to party 2, the invoice should be recorded in party 1's accounts receivable sub ledger as an open item. The accounting department 104 for party 1 records this entry in the cloud computing space 109 shared between the parties. Accordingly, the accounts receivable sub ledger for party 1 reflects an increase in the receivables by the recorded amount. The cloud computing space 109 calculates the corresponding accounting item for party 2. The cloud computing space 109 also automatically creates and populates a corresponding entry into the accounts payable sub ledger for party 2, thereby creating an open item in party 2's accounts payable sub ledger.

Upon receiving the invoice by party 2, the accounting department 108 would not need to create a corresponding open item in its accounts payable sub ledger, thereby saving time and preventing random error in making the entry. Furthermore, sometimes there is a time lag between receiving an invoice and recording the invoice as an open item by the accounting department. Consolidating and interconnecting the accounting sub ledgers according to this exemplary embodiment using the cloud computing space 109 eliminates any time lags, because the accounts payable sub ledger already reflects and includes this open item. Cloud computing space 109 becomes a universal source of truth between the parties and each party may refer to it at any time for reference.

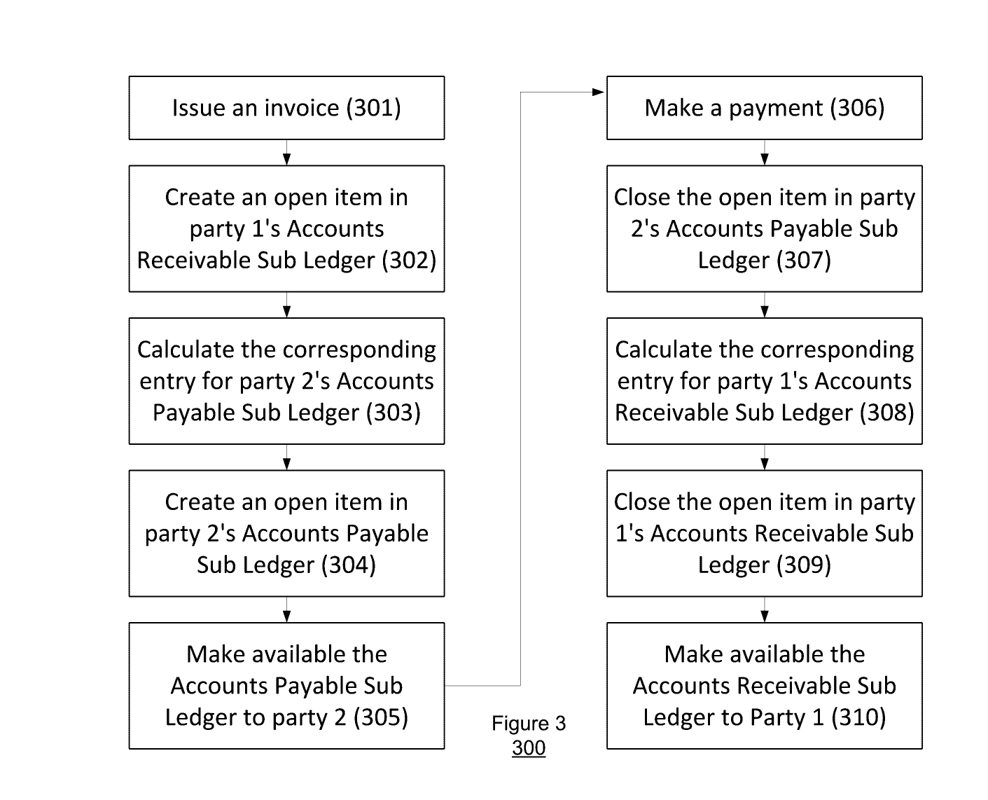

FIG. 3 is a flowchart of an exemplary method for consolidating and interconnecting accounting sub ledger according to an example embodiment. In step 301, a business event which is susceptible to an accounting entry in a party's sub ledger takes place. In this exemplary embodiment, the business event is issuing an invoice to party 2 by party 1. Accordingly, an open item in party 1's accounts receivable sub ledger is created in step 302. Subsequently, in step 303, a corresponding entry for party 2's accounts payable sub ledger is calculated. In step 304, the calculated entry is entered into party 2's accounts payable sub ledger. In step 305, the open item and sub ledger are made available to party 2.

In an exemplary embodiment of the exemplary method, the steps may end here. In another exemplary embodiment of the exemplary method, however, the steps may continue for other subsequently related business events. For example, party 2 may make a payment for the purchased goods in step 306. In step 307, the open item in party 2's accounts payable sub ledger may be closed. Subsequently, in step 308, the corresponding entry for party 1's accounts receivable sub ledger may be calculated. In step 309, the open item may be closed in party 1's accounts receivable sub ledger. Lastly, the closure of the open item and sub ledger are made available to party 1 in step 310.

One of ordinary skill in the art recognizes that business events which may create accounting events are not limited to issuing an invoice or paying for the invoice. Furthermore, an exemplary embodiment of the exemplary method may have more or fewer business events.

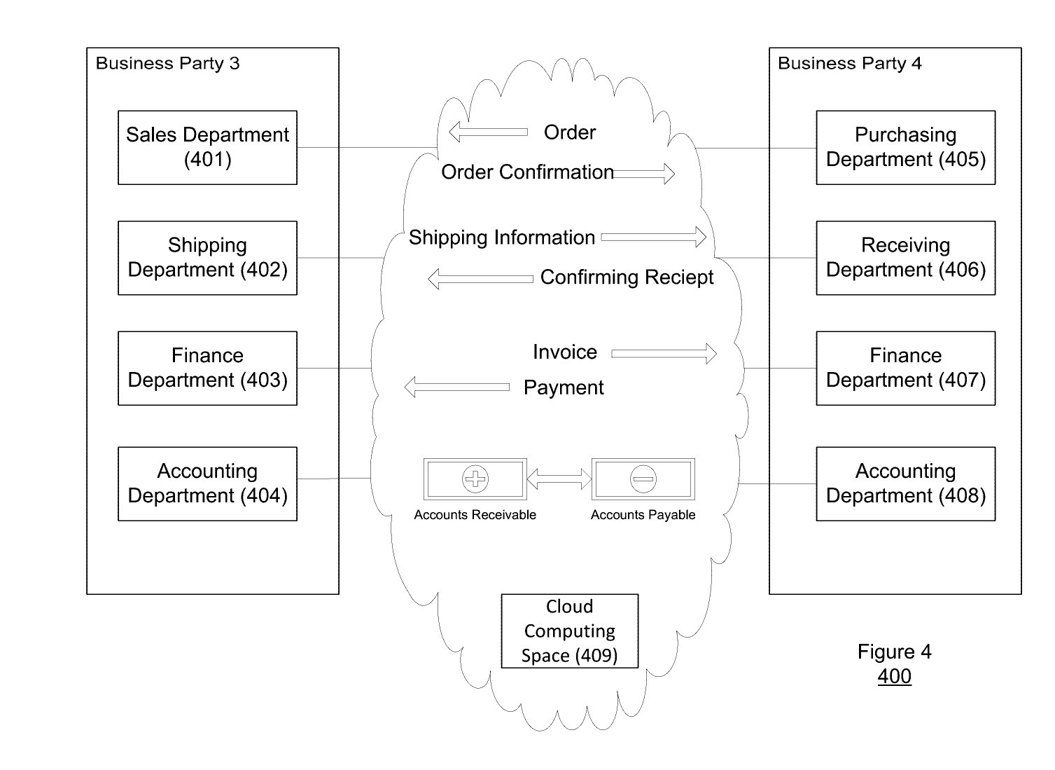

FIG. 4 illustrates an exemplary accounting operations system 400 consolidated and interconnected according to a second example embodiment. Accounting operations system 400 includes two business parties 3 and 4. Business party 3 may be a seller and business party 4 may be a buyer. However, none of the exemplary embodiments are limited to this arrangement and the business parties may engage in other forms of business dealings. For example, each party may be a buyer and seller at the same time.

Each business party has its own internal business entities. In FIG. 4, for example, business party 3 comprises a sales department 401, shipping department 402, finance department 403, and accounting department 404. Similarly, business party 4 comprises a purchasing department 405, receiving department 406, finance department 407, and accounting department 408. Each business party may comprise fewer or more entities.

The business parties 3 and 4 share a cloud computing space 409. In this exemplary embodiment, the cloud computing space 409, in addition to interconnecting and consolidating the sub ledgers of the parties, interconnects and consolidates their business processes. For example, the purchasing department 405 of business party 4 places an order for goods with sales department 401 of party 3. This order is placed on the cloud computing space 409 shared between the parties. Upon placement of this order, information concerning the order becomes immediately available to business party 3. In an example embodiment, in addition to being available on the cloud computing space 409, this information is transmitted to the business party 3 electronically. Upon becoming aware of the order, business party 3 confirms the order through the cloud computing space 409. After confirmation of the order, shipping department 402 becomes aware of the order and ships out the order. Shipping department 402 adds the shipping information relating to the order to the cloud computing space 409. Business party 4 becomes aware of the information. Upon receiving the goods, business party 4 confirms receiving them. Business party 4 places this information on the cloud computing space 409. Upon learning about the delivery of goods, business party 3 may issue an invoice for the goods sold. This invoice will be available on the cloud computing space 409. The finance department 407 of Business party 4 learns about the outstanding invoice and may issue a payment.

This exemplary embodiment integrates and interconnects the business processes as well as the accounting processes. For example, upon issuing an invoice by business party 3, the cloud computing space 409 may automatically, or upon the request of an entity of business party 3 (e.g. Accounting department 404), create an open item in the accounts receivable sub ledger of business party 3. In an embodiment, the cloud computing space 409 may also create an open item in the accounts payable sub ledger of business party 4. In an embodiment, automatically, or upon approval of the finance department 407 of business party 4, a payment is issued to the business party 3. Upon issuance of the payment, cloud computing space 409 may close the open item on the business party 4's accounts payable sub ledger. In an embodiment, upon closing the open item on Party 4's accounts payable sub ledger, business party 3's accounts receivable sub ledger is also simultaneously updated, reflecting the payment. Thus, the open item for purchase of the goods will be closed.

As a result of integration and interconnection of business and accounting processes, each business party benefits. Because the processes are conducted on a cloud computing space, each party may become aware of each interaction in real time, thereby reducing any time lag in communication. There is only one instance of the order and hence inconsistencies are systematically prevented. Furthermore, discrepancies in information due to differing format, language or interpretation are avoided. Each party has access to the same source of universal truth and any duplication of efforts is systematically avoided.

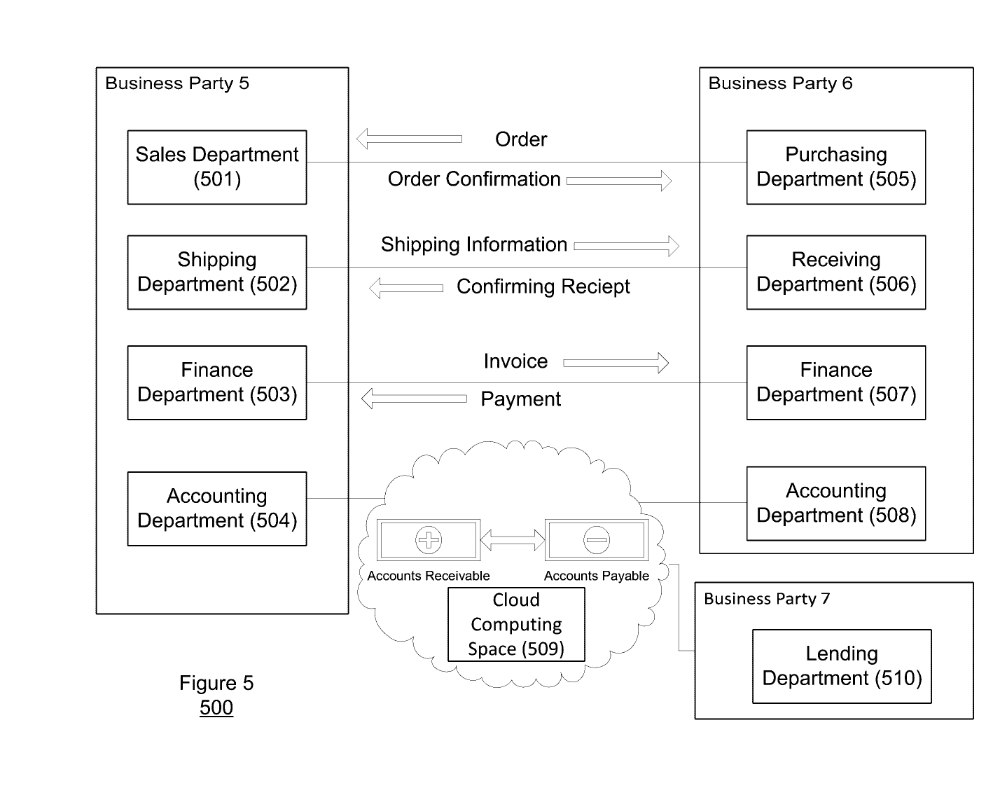

FIG. 5 illustrates an exemplary accounting operations system 500 consolidated and interconnected according to a third example embodiment. The accounting operations system 500, similar to the accounting operations system 100 of FIG. 1 has consolidated and interconnected the accounting operations between business parties 5, 6, and 7. In this example embodiment, business party 5 is a seller, business party 6 is a buyer and business party 7 is a bank (i.e. lender). In this example embodiment, business party 7 finances the purchases of business party 6 from business party 5. However, this arrangement of the business parties is not the only arrangement of the parties that can benefit from the accounting operations system 500 of this example embodiment.

Each business party has its own internal business entities. In this exemplary embodiment, business party 5 comprises a sales department 501, shipping department 502, finance department 503, and accounting department 504. Similarly, business party 6 comprises a purchasing department 505, receiving department 506, finance department 507, and accounting department 508. Business party 7 comprises a lending department 510. Each business party may comprise fewer or more entities.

In this exemplary embodiment, a transaction between business parties 5, 6, and 7 may include the following: Party 6 places an order with party 5. Party 5 provides an order confirmation to party 6. Thereafter, party 5 ships out the ordered goods and provides the shipping information to party 6. Upon receiving the shipment, party 6 confirms the delivery. Subsequently, party 5 sends out an invoice for the goods sold. Upon receiving the invoice, party 7 extends a loan to party 6 and disburses the funds to party 5 as payment for the invoice. This is only an exemplary transaction. One of ordinary skill in the art recognizes that a transaction may include fewer or more steps, may be conducted in a different order, and is not limited to purchase of goods.

The business parties share a cloud computing space 509 among each other. Each party has access to some or all of the information stored and calculated on the cloud computing space 509. Each party may also have authorization to write or edit some or none of the information on the cloud computing space 509.

Some of the business interactions between the parties in this example embodiment create accounting events. For example, upon issuing an invoice by the accounting department 504 of business party 5 to business party 6, an open item is made in the accounts receivable sub edger of business party 5, which increases the receivables by the invoiced amount. This open item relates to the purchased goods. The accounting department 504 of business party 5 creates this entry on the cloud computing space 509 on the accounts receivable sub ledger. The cloud computing space 509 also automatically creates an open item in the accounts payable sub ledger for party 6. The cloud computing space 509 automatically makes accessible this information to business parties 6 and 7.

Upon receiving the invoice issued by business party 5, business party 6 does not need to duplicate an entry in its accounts payable sub ledger as the item is already recorded. The same information is also available to business party 7, which is the bank in this example embodiment. In an example embodiment, business party 6 notifies the bank and requests the bank to extend a loan to it. In another example embodiment, the bank automatically extends a loan to business party 6 upon learning about the open item. Upon extending the loan, the bank creates an open item in its sub ledger on the cloud computing space 509 for business party 6, showing the amount owed. This open item relates to the loan extended to business party 6. At the same time, the cloud computing space 509 calculates and makes a similar entry in business party 6's sub ledger and makes this information available to business party 6.

Upon receiving the loan disbursement by business party 5, business party 5 closes the open item relating to the purchased goods in its accounts receivable sub ledger. Upon closure of the open item, cloud computing space 509 also automatically closes the open item relating to the purchased goods in business party 6's accounts payable sub ledger. Overall, there are no open items between parties 5 and 6. The only remaining open item between the parties is the loan extended to business party 6 by the bank.

Accounting operations system 500 provided in this exemplary embodiment reduces the time and effort required to maintain and upkeep the sub ledgers of the parties as it automatically calculates, creates, and updates the relevant entries. Moreover, it enhances the quality and accuracy of the sub ledgers by reducing many sources of random error.

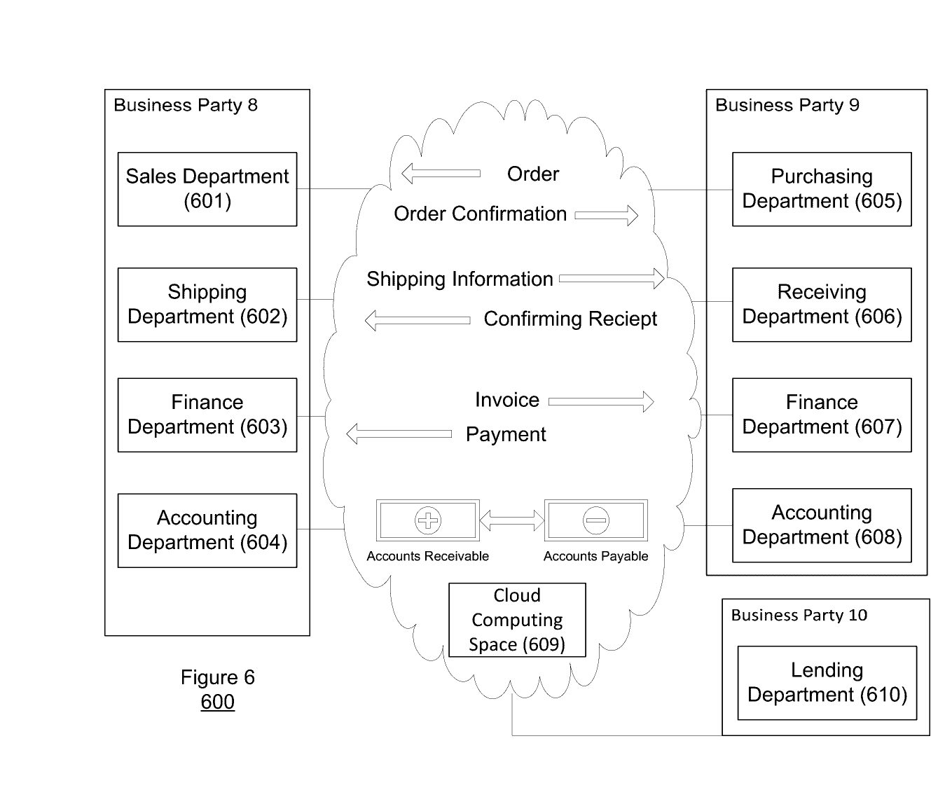

FIG. 6 illustrates an exemplary accounting operations system 600 interconnected and consolidated according to a fourth example embodiment. Similar to accounting operations system 500 of FIG. 5, there are three business parties in this exemplary embodiment: business parties 8, 9, and 10. Business party 8 may be a seller, business party 9 may be a buyer, and business party 10 may be a bank. In this example embodiment, in addition to accounting operations, the business processes of the parties are moved to the cloud computing space 609.

Each business party has its own internal business entities. In this exemplary embodiment, business party 8 comprises a sales department 601, shipping department 602, finance department 603, and accounting department 604. Similarly, business party 9 comprises a purchasing department 605, receiving department 606, finance department 607, and accounting department 608. Business party 10 comprises a lending department 610. Each business party may comprise fewer or more entities.

In this exemplary embodiment, the purchasing department 605 of business party 9 places an order with business party 8. This order is placed on the cloud computing space 609 shared between the parties. Upon placement of this request, this information becomes available to business party 8. Business party 8 confirms the order through the cloud computing space 609. After confirming the order, shipping department 602 becomes aware of the order and ships out the order. Shipping department 602 adds the shipping information relating to the order to the cloud computing space 609. Business party 9 becomes aware of the information. Upon receiving the goods, business party 9 confirms the delivery. Business party 9 places this information on the cloud computing space 609. In an example embodiment, in addition to making each piece of information available on the cloud computing space 609, the information may also be electronically transmitted to one or more of the parties.

Up to this point, all, some, or none of the information may have been accessible to business party 10. Upon learning about the delivery of goods, business party 8 may issue an invoice for the goods sold. This invoice will be available on the cloud computing space 609. The finance department 607 of Business party 9 learns about the outstanding invoice. The bank may also learn about the invoice through the cloud computing space 609.

In this example embodiment, some of the business interactions between the parties create an accounting event. For example, issuing an invoice to party 9 may create an accounting event. Upon issuing the invoice to the business party 9, the cloud computing space 609 may create the relevant open item in the accounts receivable sub ledger for business party 8. This open item relates to the purchased goods. In an example embodiment, the cloud computing space 609 may also create the corresponding item in the accounts payable sub ledger for business party 9. In an example embodiment, the cloud computing space 609 may also create the relevant accounting item in the bank's sub ledger. Since the bank may be aware of the issued invoice, it may extend a loan to business party 9 and disburse the funds to business party 8.

Upon extending the loan, the bank creates an accounting open item in its sub ledger for business party 6, showing the amount owed. This open item relates to the loan. At the same time, the cloud computing space 609 calculates the relevant entry and makes a similar entry in business party 9's sub ledger. Cloud computing space 609 makes this information available to business party 9. Once the payment is received by the finance department 603 of business party 8, the accounting department 604 of business party 8 closes the open item relating to the purchased goods in its own accounts receivable sub ledger. The cloud computing space 609 subsequently closes the open item in business party 9's accounts payable sub ledger by calculating and entering the relevant entry. The only remaining open item will be the loan issued to business party 9 by the bank.

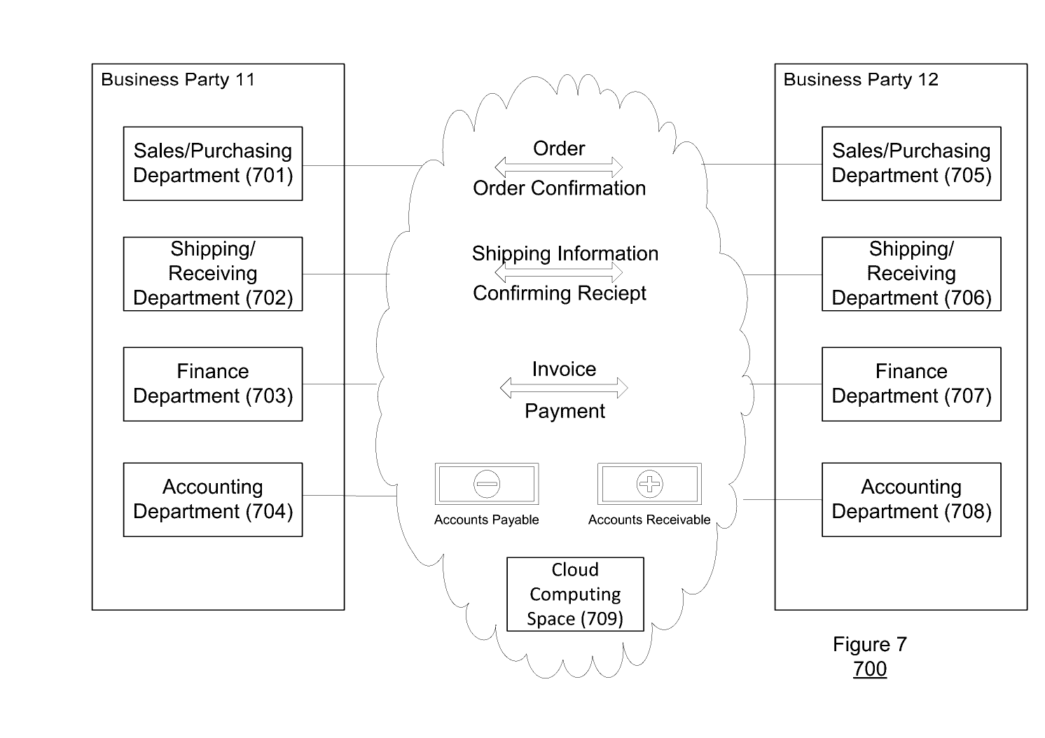

FIG. 7 illustrates an exemplary accounting operations system 700 interconnected and consolidated according to a fifth example embodiment. Accounting operations system 700 includes two business parties 11 and 12. In this exemplary embodiment, both of the business parties are buyers and sellers at the same time. Each business party has a sales/purchasing department, shipping/receiving department, finance department, and accounting department. In this exemplary embodiment, both accounting operations as well as business processes are integrated and interconnected on a cloud computing space 709. Each party engages in exemplary transactions with the other party similar to the exemplary transaction of FIG. 4. The transactions create multiple accounting events. However, because each party buys from and sells to the other party at the same time, each party simultaneously has an accounts receivable as well as an accounts payable with respect to the other party.

In an example embodiment, the parties buy from and sell to each other several times. Subsequently, each party sends an invoice to the other party via the cloud computing space 709. Upon submission of the invoice to the cloud computing space 709, the cloud computing space 709 creates open items for each one of the invoices. As a result, there will be one or several open items in each party's accounts receivable sub ledger as well as accounts payable sub ledger.

In an example embodiment, the accounts receivable sub ledger for party 11 with respect to party 12 exceeds its accounts payable. In other words, the value of party 11's goods sold exceeds the value of its purchases from party 12. In this example embodiment, the cloud computing space 709 may automatically close some of the open items between the parties.

The cloud computing space 709 adjusts the accounts payable sub ledger of party 11 to zero and reduces its accounts receivable sub ledger by the amount of accounts payable. Similarly, the cloud computing space 709 adjusts the accounts receivable sub ledger of party 12 to zero and reduces its accounts payable sub ledger by the amount of accounts receivable. As a result of implementation of accounting operations system 700, the parties' accounts are maintained and updated frequently and automatically, and the possibility of random error is minimized. The process is entirely transparent, thereby minimizing the need for reconciling the accounts.

It should be appreciated that the present invention can be implemented in numerous ways, including as a process, an apparatus, a system, a computer processor executing software instructions, a mobile device, a smart device, a mobile application, or a computer readable medium such as a computer readable storage medium, or a computer network wherein program instructions are sent over optical or electronic communication or non-transitory links. It should be noted that the order of the steps of disclosed processes can be altered within the scope of the invention, as noted in the appended Claims and in the description herein.

There are several references to exemplary transactions between the parties. One of ordinary skill in the art recognizes that a transaction may include fewer or more steps than what was listed, may be conducted in a different order, and is not limited to purchase of a goods. For each instance of the exemplary cloud computing space, some or all of the information stored on it is available to the parties which share the space among themselves. In each instance, the exemplary cloud computing space is capable of notifying each party about the availability of the information or the information itself. According to the exemplary embodiments, the parties may share one or more cloud computing spaces among themselves. One of ordinary skill in the art recognizes that business events which may create accounting events are not limited to issuing an invoice or paying for the invoice.

Although the foregoing invention has been described in some detail for purposes of clarity of understanding, it will be apparent that certain changes and modifications can be practiced within the scope of the appended claims. The present invention can be practiced according to the claims without some or all of these specific details. For the purpose of clarity, technical material that is known in the technical fields related to the invention has not been described in detail so that the present invention is not unnecessarily obscured. It should be noted that there are many alternative ways of implementing both the process and apparatus of the present invention. Accordingly, the present embodiments are to be considered as illustrative and not restrictive, and the invention is not to be limited to the details given herein, but can be modified within the scope and equivalents of the appended claims.

What is claimed is:

1. A method for integrating accounting operations between at least two business parties, the method comprising:
engaging in a business transaction which creates an accounting entry;
creating an open item in the first party's sub ledger relating to the business transaction;
creating a corresponding open item in the second party's sub ledger based on the open item in the first party's sub ledger; and
presenting the open item and the corresponding open item to the parties.

2. The method of claim 1, wherein the first party's sub ledger and the second party's sub ledger are stored on a cloud computing space shared between the parties.

3. The method of claim 2, wherein the cloud computing space creates a corresponding open item in the second party's sub ledger based on the open item in the first party's sub ledger.

4. The method of claim 3, wherein at least part of the business transaction is conducted on the cloud computing space.

5. The method of claim 4, wherein the business transaction comprises at least one of issuing an invoice by the first party and making a payment by the second party.

6. The method of claim 5, wherein at least one of the issuing an invoice by the first party and the making a payment by the second party takes place over the cloud computing space.

7. The method of claim 6, wherein upon issuing the invoice by the first party, the cloud computing space creates the open item in the first party's sub ledger and creates the corresponding open item in the second party's sub ledger.

8. The method of claim 7, wherein upon making the payment by the second party, the cloud computing space creates an item in the second party's sub ledger and closes the open item, and creates a corresponding item in the first party's sub ledger and closes the corresponding open item.

9. The method of claim 7, wherein there are three business parties.

10. The method of claim 9, wherein the cloud computing space is shared with the third party and wherein upon issuing the invoice by the first party, the third party makes a payment to the first party.

11. The method of claim 10, wherein upon issuing the payment by the third party, the cloud computing space creates an item in the second party's sub ledger and closes the open item, and creates a corresponding item in the first party's sub ledger and closes the corresponding open item.

12. A system directed to integrating accounting operations between at least two business parties, comprising of:
a server configured to provide processing power and storage space for storing electronic data, and
at least two terminals, wherein the terminals are configured to communicate with the server and each terminal configured to read, write, store or edit information on the server;
wherein the first terminal is configured to communicate and the server is configured to store an open item in a first party's sub ledger based on a business transaction and the server is configured to store a corresponding open item in a second party's sub ledger based on the open item in the first party's sub ledger.

13. The system of claim 12, wherein the first party's sub ledger is an accounts receivable sub ledger and the second party's sub ledger is an accounts payable sub ledger.

14. The system of claim 13, wherein the business transaction comprises at least one of issuing an invoice by the first party and making a payment by the second party.

15. The system of claim 14, wherein at least part of the business transaction is communicated through the server.

16. The system of claim 15, wherein upon issuing the invoice by the first party, the first terminal communicates the invoice to the server and the server creates the open item in the first party's sub ledger and creates the corresponding open item in the second party's sub ledger.

17. The system of claim 16, wherein upon making the payment by the second party, the second terminal communicates the payment to the server and the server creates an item in the second party's sub ledger and closes the open item, and creates a corresponding item in the first party's sub ledger and closes the corresponding open item.

18. The system of claim 16, wherein there are three terminals.

19. The system of claim 18, wherein upon issuing the invoice by the first party, the third terminal communicates the payment to the server and the server creates an item in the second party's sub ledger and closes the open item, and creates a corresponding item in the first party's sub ledger and closes the corresponding open item.
